(19) United States
(12) Patent Application Publication
(10) Pub. No.: US 2005/0049882 A1
(43) Pub. Date: Mar. 3, 2005

(54) Virtual Enterprise Computer

(76) Inventor: Walter A. Sawka, Ringwood, NJ (US)

Correspondence Address: WALTER A. SAWKA, 36 COPPER HILL PARK, RINGWOOD, NJ, 07456, US

(21) Appl. No.: 10/605,002

(22) Filed: Aug. 29, 2003

(51) Int. Cl. G05B 15/00

(52) U.S. Cl. 705/1; 700/1

(57) ABSTRACT

The Virtual Enterprise Computer (VEC) is a method for creating a single virtual, enterprise-wide computing environment consisting of a single, enterprise-wide persistent address space to uniquely identify and location enterprise data and intellectual assets, a single, enterprise-wide, persistent memory as a single source for all enterprise data, resources and intellectual assets, an enterprise-wide persistent knowledge repository that models the business enterprise by maintaining relationships between business processes, workflows, business rules, business metrics, data, resources, legacy systems and intellectual assets, self-aware agents encapsulating data and computer code, a real-time event/logic controller to manage the execution of agents eliminating data pollution and data duplication, conserving knowledge assets, creating an enterprise-wide collaboration environment, enhancing the flow and sharing of information and knowledge, permitting the arbitration of intellectual resources across the business enterprise, providing a foundation architecture and knowledge infrastructure to address numerous business initiatives including: the Seamless Business Enterprise the Real-Time Business Enterprise Enterprise Knowledge Management Single-View of the Business Enterprise Enterprise Application Integration Coherent Business Enterprise Straight-Through-Processing Collaborative Work Environments Mergers and Acquisitions Single View of Customers and Suppliers Enterprise Resource Planning Enterprise Business Processing Reengineering Business Intelligence intelligent Business Enterprise Optimized Business Enterprise Enterprise Business Modeling.

### COPYRIGHT STATEMENT

Virtual Enterprise Computer. Copyright 2003. Walter A Sawka. All Rights Reserved.

Collaborative Work Environment. Copyright 2003. Walter A Sawka. All Rights Reserved.

Persistent Enterprise Address Space. Copyright 2003. Walter A Sawka. All Rights Reserved.

Enterprise Address Space. Copyright 2003. Walter A Sawka. All Rights Reserved.

Enterprise Knowledge Continuum. Copyright 2003. Walter A Sawka. All Rights Reserved.

Persistent Enterprise Knowledge Continuum. Copyright 2003. Walter A Sawka. All Rights Resserved.

Persistent Enterprise Memory. Copyright 2003. Walter A Sawka. All Rights Reserved.

### BACKGROUND OF INVENTION

Almost thirty years ago, the inventor was responsible for the design of mainframe applications. Serious performance and logical difficulties ensued if a computer application was of sufficient size such that it could not fit into a single computer system, In such situations that continue to today, applications spanning more than one computer system present very significant problems in complexity, performance, data integrity, data pollution and synchronization; applications that are spread across multiple computers present enormous difficulties including complex messaging between computers, replication of data that required virtually impossible data synchronicity to maintain data integrity, application synchronicity, complex communications protocols and so on. If a computer could be invented such that all applications and data storage needs could be handled by a single computer entity, major issues such as data pollution, cost, complexity performance could be significantly reduced including simplifying program design and maintenance. No such alternative existed until recently when the inventor invented the Virtual Enterprise Computer which is a method for multiple computers to operate as a single computer entity.

Business Enterprises rely on computers with conventional von-Neumann computer architecture (memory, control/logic unit, arithmetic unit and auxiliary storage). Since no one physical computer can handle all the required processing for a business enterprise, business enterprises use many independent computers to satisfy the totality of their processing and data storage needs and requirements. Since data and information processes is spread across independent, separate computer systems each with their own unique information stores and memory; data is duplicated across these computers without synchronicity. This creates a very complex information and technology infrastructure that is very difficult to manage and maintain and presents great difficulties in maintaining data integrity as data is replicated across multiple computer systems and applications. The enormous management and coordination challenges of a disparate group of independent computers promotes data pollution (stale, unorganized data sets) and creates data synchronicity problems and impedance mismatches (incompatibilities) across the breadth of independent computer applications and information systems.

Each computer is an independent unit encapsulating its own physical memory, disk and other storage devices; further, the functional logic and address space of each computer is independent and isolated from each other creating significant challenges in sharing information in a meaningful way. In fact, a significant portion of computer programming and resources are committed to provide a rudimentary capability to communicate between computers so data can be transmitted among multiple computers. Even when computers are linked through various communications media including the Internet and Intranets, they lack a common memory and collective, common understanding to support meaningful sharing of information since they lack a common contextual understanding. This environment is akin to a room full of people attempting to work in concert. Much effort is required to get everyone to understand the tasks at hand and work together. A multiple computer environment is very similar. Consider the enormous savings and efficiency that can be achieved if the room of workers could share a common, seamless brain and memory! This notion is at the core of the Virtual Enterprise Computer; the creation of a common, persistent, enterprise-wide, sharable, single source of all data and information.

Conventional computer methodologies and technologies can only provide the most basic of communications among computers. They can pass messages but collective understanding is obscure at best. Using the latest communications technologies provide limited addressing resolution only to the computer, not to a computer's internal data structures; conventional computer addressing of data within a computer is isolated from other computers requiring complex, custom computer programs to share data between computers with a common understanding. Even so, there is no enterprise-wide understanding of the data contained within all the computers. Each computer application is a mechanization of a particular function having its own unique interest, justification, interpretation and meaning for the data it uses without concern for the large context of which the data is part. Further, little or no concern is exists for maintaining synchronicity between multiple copies of the same data.

Even with the World Wide Web, sophisticated search engines are required to gain knowledge of the data contained within other computers' Web Pages, in which the ad hoc searcher provides the context and understanding implicit in the reason for the data search. Moreover, each computer must present pre-established mechanical means, custom web pages, typically HTML and XML documents to share data and therefore, must anticipate the needs of data searches. No means exist to do ad hoc searches of an entire computer's memory resources to access to the inherent data, information and knowledge contained in the computer because each computer has its own contextual environment of applications and information schema to give meaning to the data it stores.

In conventional databases, it is computer applications that give meaning to the relationships between the raw data stored in databases. Ad hoc SQL queries are possible. However, searches are limited to the construct of a particular database. Explicit precognizant knowledge must exist so that these searches have meaning.

Conventional computer applications consist of several distinct parts: input, data processing and output. During the input phase, computer programs create transient information schema that gives meaning to the raw data they read from relational databases. These structures are not easily available; since the programs are transient so are their information schemas. During the output phase of these programs the information schemas are reduced to raw data contained in relational databases. Therefore, only the results of the processing are saved, not the interrelationship of the raw data itself, which remain imbedded and inaccessible in the computer applications.

The typical business enterprise has hundreds to thousands of disparate computer systems acting as file and application servers using legacy mainframe computers based primarily on IBM MVS mainframes, and UNIX and Microsoft Windows file and application servers. Many computers are required because of enormous data processing, and storage demands. The “point solutions” paradigm that argues for each automation implementation to serve individual isolated needs with little or no regard to integration within a larger logical infrastructure and enterprise-wide information sharing creates a fragmented and inconsistent approach to conservation enterprise knowledge and information. Further, the conventional paradigm for computer application design follows closely the paradigm for computer hardware architecture, i.e., timesharing, client/server, web-based computing. Thus, conventional computer software application architecture closely parallels computer hardware technology.

As we have previously indicated, conventional application and database architecture creates isolated independent units with their own memory context and data storage. Since each computer has its own independent memory and application processing, complex messaging and data sharing strategies need to be implemented to permit the sharing of data between computer systems. The problem is so complex that no effective and efficient strategy till now has been developed to provide for the convenient and extensible sharing of data and building enterprise-wide knowledge and information schema, that is, the modeling of the business enterprise in real-time (timely business information).

Moreover, current computer technologies are used to store data, documents and information in independent database and files systems in which each database and file system is isolated and incompatible with other systems and in which computer applications are unaware of other databases and file systems; applications maintain their is own standards for data integrity and definition even though they often replicate data from other computer applications. Thus, data and information is fragmented, unsynchronized and often stale and is not easily combined to provide an enterprise-wide perspective of a business enterprise's operations and resources as defined in its data and information assets, provide a coherent view of the business enterprise as a whole; they inherently create enormous data pollution problems.

The Virtual Enterprise-wide Computer obviates the need for creating “point solution” computer automation and eliminated “Islands of Automation”. The single Virtual, Enterprise Computer uses my inventions of a Persistent Enterprise(-wide) Memory (Persistent Enterprise Continuum) and Persistent Enterprise-wide Linear Address Space; the VEC creates a data processing environment greatly simplifying the creation and management of enterprise computer applications creating a seamless fabric of knowledge and information that spans the enterprise; it provides persistent information and knowledge schema conveniently available to knowledge workers and executive management to enhance collaboration and reduce errors by providing timely (real-time) business knowledge and information integrated into enterprise-wide business models.

[Prior Art]

Over the last decade, many techniques have been developed in the attempt to address the issues of disparate, isolated computer systems, applications and information systems. These approaches are piece-meal because they only treat symptoms and only focus on specific business functions, not the entire business enterprise; that is, some of these approaches automate enterprise functions such as supply chain management, they fail to address the needs of the entire enterprise. Further, they all share a hard-wired approach, implementing a fixed, inflexible solution that cannot address changing business needs. Additionally, the information in these systems is difficult to extract as demonstrated by the need to develop web-based front-ends to extract data for other uses. These automation efforts are only enterprise solutions in the most limited of context and include:
(a) Enterprise Resource Management,
(b) Human Resource Management,
(c) Oracle Financial Applications,
(d) Web-based Front-ends to Back Office Databases,
(e) Bus Architectures,
(f) Business Intelligence,
(g) Client/Server Compute Application Architectures,
(h) Timesharing, and
(i) Mainframe Applications.

None of these approaches provide enterprise-wide, single views of the business enterprise. They are solutions to address specific functional areas hardwiring data to particular business functions. Finally, they are built on the outdated computer technologies such as relational databases.

Specific disadvantages of prior art include:
(a) no enterprise-wide persistent shared memory,
(b) no single enterprise-wide addressing scheme for data, information and knowledge,
(c) data must be searched and accessed by value not location or address,
(d) no persistent enterprise-wide shared common data or information schema,
(e) no enterprise-wide common framework and architecture,
(f) no historical records, lack of versions of data and information,
(g) complex computer interconnections and messaging required to disparate computer systems,
(h) no single enterprise event/logic controller: real-time monitor,
(i) information stored in its raw data form typically in relational databases making it difficult to extract knowledge,
(j) application centric: little or no persistence of the business relationships between data elements,
(k) large monolithic programs in which processing and information schema (relationships between raw data elements) is inaccessible and inflexible,
(l) cannot easily maintain complex data and information relationships or complex data types including sophisticated graphical information or Computer Aided technical drawings, and
(m) cannot maintain persistent complex data and information relationships or complex data types including sophisticated graphical information or Computer Aided technical drawings.

Relational databases cannot create enterprise-wide information schema without significant data replication, building complex, inefficient table structures and reliance on outer-joins between relational database tables. Technological limits of tables within relational databases prevent creating enterprise-wide views of business enterprises without extraordinary means such as replication servers and data replication. Further, outer-joins, the combination of data across relational database tables—a necessity for building complex, enterprise-wide information schema significantly impact performance and efficiency.

[Objectives and Advantages]

The Virtual Enterprise Computer's advantages and objectives include:
(a) a method for the storage and processes of data and information not limited to the processing and storage limitions of a single convention computer,
(b) a single common enterprise-wide address space and memory sufficiently robust has to manage a business enterprise's entire processing and data storage needs within a single context,
(c) a single data storage mechanism and processing environment simplifying building enterprise solutions and integrating all data and information sources into a common enterprise-wide processing and storage environment,
(d) an extensible, enterprise-wide environment without practical processing or storage limitations,
(e) a single source for all intellectual assets including but not limited to data, information, knowledge, know-how and documents eliminating redundancy, duplication and inconsistency,
(f) a seamless enterprise-wide object-oriented computer application environment,
(g) data centric solution: relationships between data, information knowledge, business process, business workflows, business metrics, and business rules into coherent business models maintained within the Persistent Enterprise-wide Memory (Persistent Enterprise Memory),
(h) model of the business enterprise aligning intellectual assets with business processes creating knowledge,
(i) timely (real-time) business information,
(j) a seamless enterprise-wide information technology infrastructure to conserve business knowledge,
(k) a single coherent view of the business enterprise,
(l) flexibility and extensibility to support Change Management Strategies.

### SUMMARY OF INVENTION

The Virtual Enterprise Computer is a model of a single logical computer running all the programs and managing all the intellectual assets of a business enterprise. It is a model which greatly simplifies the implementation and management of enterprise automation solutions.

The Virtual Enterprise Computer physical embodiment is a TCP/IP network of UNIX-based and/or Microsoft Windows-based computers operating over private intranets and/or Internet.

Each computer in the network runs an object database in which data in each computer is identified by a unique identification code. Each object database maintains its own unique object identifiers.

The object databases in all the computers are integrated into single a persistent enterprise-wide store through the use of a Persistent Enterprise-wide Addressing Space (PEAS) schema that uniquely identifies the location of all data assets within the VEC. PEAS maintains system tables that map logical identifiers of data assets to physical addresses consisting of a machine code address, TCP/IP address and object identifiers within the object databases. That is, each data asset has a PEAS logical identifier that identifies the location of the computer containing the data and its internal location within the computer. Thus, the object databases are logically connected through PEAS creating a single logical storage device spanning the entire network of computers within the VEC called the VEC Main Memory.

VEC's Main Memory is the VEC's logical processing environment. It is a methodology for addressing and managing the persistent elements stored in VEC consisting of Agents encapsulating data and computer code. Each Agent has a persistent logical address. It provides for the logical consistency and persistence of Agents. VEC's logical processing environment ensure referential integrity among Agents, load Agents for execution and perform associated management a security operations.

Agents are the common architecture for enterprise data and their associated methods. Agents are created and controlled through Application Program Interfaces based on C++ or Java. They are a concatenation of data and code, methods, specific to the data. The Agents provide many functional purposes from interfaces between disparate systems to the Real-Time Monitor.

Agents are used to create a Persistent Enterprise-wide Memory (PEM): Persistent Enterprise Continuum that contains the complex relationship of all enterprise data; relationships between data assets create information schema, business processes, rules and metrics, and knowledge. The PEM is the business enterprise's knowledge repository with the unique characteristic of being singular, persistent and data centric.

Relying on the Persistent Enterprise Address Space with the additional concept of self-aware objects called Agents, creates a Persistent Enterprise-wide Memory (Persistent Enterprise Continuum) for the processing and management of all enterprise intellectual assets and which distinguishes this technology from conventional object databases. Agents, the fundamental architectural element of data and information entities with their methods (programs) are managed and located through unique addresses within the Persistent Enterprise Memory; they interact to accomplish specific processing of intellectual assets; the agents are maintained in the VEC's main memory managed and controlled by the Event/Logic Controller which decides which Agents are to execute their program code based on the occurrence of pre-established events within the business enterprise. The Event/Logic Controller loads Agents to be executed in a wrapper program with the Controller, executing the desired code.

Modeling of the business enterprise's tangible and intangible resources, assets, processes and workflows is accomplished by direct one-to-one mapping to Agents, which creates the Persistent Enterprise-wide Memory (Persistent Enterprise Continuum).

The Virtual Enterprise Computer provides the method and infrastructure to build Enterprise Computer Applications and implement Enterprise Application Integration. By virtual of a single common, enterprise-wide memory, and a common, enterprise-wide processing environment, enterprise-wide applications are made practical. It is an effective solution to business initiatives that here-to-for had no practical implementation including
(a) Seamless Business Enterprise,
(b) Real-Time Business Enterprise,
(c) Single View of the Business Enterprise,
(d) Single View of Customers and Suppliers,
(e) Enterprise Application Integration,
(f) Straight-Through-Processing,
(g) Coherent Business Enterprise,
(h) Optimized Business Enterprise,
(i) Intelligent Business Enterprise,
(j) Enterprise Business Intelligence,
(k) Mergers and Acquisitions,
(l) Collaborative Work Environments,
(m) Enterprise Resource Planning,
(n) Enterprise Business Modeling,
(o) Enterprise Knowledge Management, and
(p) Enterprise Business Intelligence.

### BRIEF DESCRIPTION OF DRAWINGS

FIG. 1, Virtual Enterprise Computer Overview, shows the major components of the invention indicating key relationships between the major components.

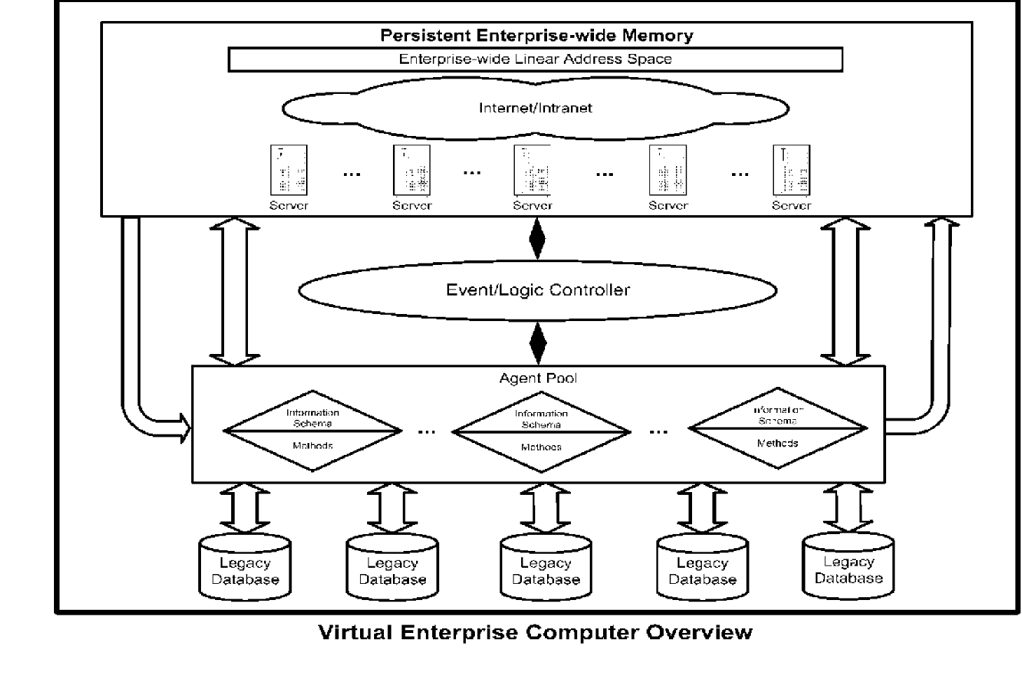

### DETAILED DESCRIPTION

The Virtual Enterprise Computer is a model of a single logical computer running all the programs and managing all the intellectual assets of a business enterprise including its virtual components (partners and vendors). It is a model which greatly simplifying the implementation and management of enterprise automation solutions.

The Virtual Enterprise Computer physical embodiment is a TCP/IP network of UNIX-based and/or Microsoft Windows-based computers operating over private intranets and/or Internet.

Each computer in the network runs an object database in which data in each computer is identified by a unique identification code. Each object database maintains its own unique object identifiers.

The object databases in all the computers are integrated into single a persistent enterprise-wide store through the use of a Persistent Enterprise-wide Addressing Space (PEAS) schema that uniquely identifies the location of all data assets within the VEC. PEAS maintains system tables that map logical identifiers of data assets to physical addresses consisting of a machine code address, TCP/IP address and object identifiers within the object databases. That is, each data asset has a PEAS logical identifier that identifies the location of the computer containing the data and its internal location within the computer. Thus, the object databases are logically connected through PEAS creating a single logical storage device spanning the entire network of computers within the VEC called the VEC Main Memory.

VEC's Main Memory is the VEC's logical processing environment. It is a methodology for addressing and managing the persistent elements stored in VEC consisting of Agents encapsulating data and computer code. Each Agent has a persistent logical address. It provides for the logical consistency and persistence of Agents. VEC's logical processing environment ensure referential integrity among Agents, load Agents for execution and perform associated management a security operations.

Agents are the common architecture for enterprise data and their associated methods. Agents are created and controlled through Application Program Interfaces based on C++ or Java. They are a concatenation of data and code, methods, specific to the data. The Agents provide many functional purposes from interfaces between disparate systems to the Real-Time Monitor.

Agents are used to create a Persistent Enterprise-wide Memory (PEM): Persistent Enterprise Continuum that contains the complex relationship of all enterprise data; relationships between data assets create information schema, business processes, rules and metrics, and knowledge. The PEM is the business enterprise's knowledge repository with the unique characteristic of being singular, persistent and data centric.

Relying on this addressing notion with the additional concept of self-aware objects called Agents, creates a Persistent Enterprise-wide Memory (Persistent Enterprise Continuum) for the processing and management of all enterprise intellectual assets and which distinguishes this technology from conventional object databases. Agents, the fundamental architectural element of data and information entities with their methods (programs) are managed and located through unique addresses within the Persistent Enterprise Memory; they interact to accomplish specific processing of intellectual assets; the agents are maintained in the VEC's main memory managed and controlled by the Event/Logic Controller which decides which Agents are to execute their program code based on the occurrence of pre-established events within the business enterprise. The Event/Logic Controller loads Agents to be executed in a wrapper program with the Controller, executing the desired code.

Modeling of the business enterprise's tangible and intangible resources, assets, processes and workflows is accomplished by direct one-to-one mapping to Agents, which creates the Persistent Enterprise-wide Memory (Persistent Enterprise Continuum).

[Component (Static) View]

The components of the Virtual Enterprise Computer (VEC) including:
(a) Persistent Enterprise-wide Linear Address Space,
(b) VEC Main Memory called the Persistent Enterprise Memory: Persistent Enterprise Continuum,
(c) TCP/IP Network,
(d) Event/Logic Controller: Real-Time Monitor,
(e) Self-Aware Agents (Information and Data encapsulated with computer code called Methods),
(f) Adapter Agents acting as logical interfaces to interconnect legacy data to Agents within the Persistent Enterprise-wide Memory,
(g) Object-oriented Database acting as a storage medium within each computer resource, and
(h) Object-oriented Database acting as a storage medium within each computer resource, and Internet/Intranets.

An address schema that identifies data and information assets by unique logical identification that is mapped to specific physical locations consisting of a computer addresses (unique internet address) and object id within each computer system.

Address Tables that map unique information and data resource identification numbers to physical addresses on the network.

The Persistent Enterprise Address Space creates a persistent linear enterprise-wide address space in which each information and data asset has a unique logical identification that is mapped to a unique physical address on a specific computer resource within the internet/intranet indicated in the above diagram. This capability permits the creation of a coherent persistent enterprise memory. Address tables maintain the mapping of logical address to specific physical address. When a data object is required it is acquired through a read operation that finds the physical objects location by querying the Address tables, reads the data and presents it to the requesting program.

Each information and data asset is a conventional object-oriented entity containing computer application code and data. The combination creates what is called an Agent. Agents execute according the instructions from the Event/Logic Controller, which controls the overall operation of the Virtual Enterprise Computer. A conventional von Neumann computer architecture is created out of a networked collection of computer resources operating on a TCP/IP network.

A Systems Library provides for the necessary functions to control the overall operation of the Virtual Enterprise Computer and provide program interfaces to provide standard system functions including the reading, writing and deletion of data.

[Operation Preferred Embodiment]

The Virtual Enterprise Computer logically operates as if it is a single computer entity by integrating multiple, physically dispersed computers into a single functional entity by virtue of the Persistent Enterprise-wide Address Space and a collection of system functions provided by the Event/Logic Controller and support libraries. Each physical computer within the VEC infrastructure is running an object database and responds to requests for data. Client computers outside of infrastructure of VEC make the requests for data. The Client computers or the VEC itself depending upon design and performance considerations for each application can perform execution of Agents.

VEC's Event/Logic Controller: Real-Time Controller (ELC) operates within VEC's Main Memory and is an Agent itself. Once an event occurs, the ELC calls the appropriate Agent(s) for execution. Since all Agents have there own unique logic address, Agents are easily located and accessed by routine software functions provided by the Systems Library to load and execute Agents.

When data is required from legacy databases, Adapter Agents are called which read the appropriate information. Similarly, when data needs to be written to legacy databases, Adapter Agents write the data to appropriate databases.

The VEC provides for security by providing access lists with password control. Additionally, the VEC supports conventional security measures including firewalls and other standard security controls.

In the event of a computer failure within the VEC, backup and restore capabilities are provided to restore lost data.

Developing new applications is as simple as creating a collection of new Agents, not unlike creating functions with the C programming language where there is a “main” function. Within the applications, there is a main Agent that is called first and either directly or indirectly controls the execution of other Agents within the application collection of Agents. However, large collections are strictly discouraged since the notion of large monolithic applications work contrary to the principles of VEC. It is primarily the role of the Event/Logic Control to manage the execution of Agents. Thus, what is created is self-aware objects, a genetic programming model, in which Agents are executed upon a specific event occurring.

Data is fetched through pre-established program calls to Agents within the library of system functions which gets the data for processing by its unique enterprise address or searches for the data by value. Writing and deletion of data occurs in similar fashion.

[Detailed Description—Alternate Embodiment]

The Virtual Enterprise Computer relies on object technology and an object-oriented database. However, similar but less efficient results can be achieved using conventional relational database technology. In this case, each data element is given a unique identification number. An index is provided which identifies and links the unique identification number to its physical location within the data stores. Agents still exist but in a more primitive form in which data and information schema are depopulated into basic data stored in relational databases. Alternatively, an object store can be used to manage agents.

1. What I claim as my invention is a method for a single, enterprise-wide virtual computer (Virtual Enterprise Computer) using a network of physically dispersed, traditional computers operating as a single entity comprising (a) a single, enterprise-wide Persistent Address Space to uniquely identify and location enterprise data and intellectual assets, (b) a single, enterprise-wide, persistent memory (Persistent Enterprise Memory) as a single source for all enterprise data, information, resources and intellectual assets (c) an enterprise-wide, persistent, logical knowledge infrastructure that models the business enterprise by maintaining relationships between business processes, workflows, business rules, business metrics, data, resources, legacy systems and intellectual assets detailing all significant enterprise entities regardless if they are tangible or intangible, (d) self-aware Agents encapsulating data and computer code, (e) System Libraries to implement the Virtual Enterprise Computer logical operations and to interface computer applications to the Virtual Enterprise Computer, and (f) a Real-Time Event/Logic Controller to manage the execution of agents, whereby said system operates as a single logical enterprise-wide computing system to provide all the data processing and data storage required by a business enterprise, whereby said system is a single coherent source of enterprise data, information, documents, resources and intellectual assets eliminating data pollution, erroneous data, and data duplication, whereby said system is a shared repository of timely (real-time) business information creating an enterprise-wide collaboration environment enhancing the flow and sharing of knowledge and information and source of business intelligence, whereby said system is a platform for enterprise computer application integration providing enterprise-wide computer application management, whereby said system is a real-time model of the business enterprise integrating functional business units and independent processes and workflows into integrated coherent views of the business, whereby said system conserves knowledge assets, whereby said method is an extensible and expandable to adapt to changing requirements and needs, and whereby said system is the foundation architecture and knowledge infrastructure to uniquely support strategic business initiatives including:
(a) the Seamless Business Enterprise,
(b) the Real-Time Business Enterprise,
(c) Enterprise Knowledge Management,
(d) Single-View of the Business Enterprise,
(e) Enterprise Application Integration,
(f) the Coherent Business Enterprise,
(g) Straight-Through-Processing,
(h) Collaborative Work Environments,
(i) Mergers and Acquisitions,
(j) Single View of Customers and Suppliers,
(k) Enterprise Resource Planning,
(l) Enterprise Business Process Reengineering,
(m) Intelligent Business Enterprise,
(n) Enterprise Business Intelligence, and
(o) Optimized Business Enterprise
(p) Enterprise Business Modeling.
